(19) United States
(12) Patent Application Publication
(10) Pub. No.: US 2010/0053413 A1
(43) Pub. Date: Mar. 4, 2010

(54) IMAGE PICKUP APPARATUS

(75) Inventors: Kazunobu Uchida, Kanagawa (JP); Yasuhiko Sasaki, Saitama (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/323,317

(22) Filed: Nov. 25, 2008

(30) Foreign Application Priority Data
Aug. 26, 2008 (JP) 2008-216211

(51) Int. Cl. H04N 5/225

(52) U.S. Cl. 348/340; 348/E05.024

(57) ABSTRACT

An image pickup apparatus 1 includes a scope 20 and a lens as objective optical modules for limiting a scope image pickup area 200, an image pickup device 22A connected to the objective optical module for picking up an image on an image pickup surface, and a signal processing portion 3 setting a photometric area 202 on the image pickup surface of the image pickup device 22A for measuring a light receiving state, as well as setting a size of the photometric area 202 to be variable.

The present application is based on Japanese patent application No. 2008-216211, the entire contents of which are incorporated herein by reference.

### BACKGROUND

1. Field

The present invention rerates to an image pickup apparatus.

2. Description of the Related Art

A conventional image pickup apparatus is known in which a photometric area is modified in accordance with a variation of an image pickup area (for example, disclosed in Japanese Patent Application No. 2002-10975).

The image pickup apparatus has an objective optical module composed of a scope, a lens or the like, an image pickup device composed of a CCD (Charge Coupled Device), a CMOS (Complementary Metal Oxide Semiconductor), or the like, a memory for storing image pickup area information which corresponds to the scope, a photometric portion for measuring a light receiving state on the image pickup device by using divided photometric areas, and a controlling portion for controlling each portion. Since the controlling portion modifies a size of the divided photometric areas in the photometric portion with reference to the image pickup area information when a change of the objective optical module is detected, it is possible to carry out a measurement of a light receiving state suitable for the objective optical module.

However, according to the conventional image pickup apparatus, since the size of the divided photometric area is modified so as to include an image pickup area within the divided photometric areas, there is a problem that it is necessary to increase the division number of the divided photometric areas in order to carry out the photometric of the image pickup area in more detail, which results increase of calculation cost required for the photometry in the controlling portion.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram showing a configuration example of an image pickup apparatus according to an embodiment of the invention;

FIGS. 2A and 2B are schematic diagrams showing an image pickup area of the image pickup apparatus according to an embodiment of the invention;

FIG. 3 is a schematic diagram showing a photometric area of the image pickup apparatus according to an embodiment of the Invention; and

FIGS. 4A to 4H are schematic diagrams showing example operations of the image pickup apparatus according to an embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided an image pickup apparatus, including: an objective optical module for limiting an image pickup area; an image pickup device connected to the objective optical module for picking up an image on an image pickup surface; and a signal processing portion settling a photometric area on the image pickup surface of the image pickup device for measuring a light receiving state, as well as setting a size of the photometric area to be variable.

According to the constitution as described above, since the photometric area is set to be variable, it is possible to carry out a measurement of an accurate light receiving state by modifying a size of the photometric area without increasing the calculation cost even when the image pickup area is limited by the objective optical module.

In addition, according to a further embodiment of the invention, there is provided an image pickup apparatus, including an image pickup device for picking up an image on an image pickup surface; an objective optical module connected to the image pickup device for limiting an image pickup area on the image pickup surface; and a signal processing portion setting a photometric area on the image pickup surface of the image pickup device for measuring a light receiving state, as well as setting a size of the photometric area to be variable for providing the photometric area within the image pickup area limited by the objective optical module.

According to the constitution as described above, it is possible to carry out a measurement of an accurate light receiving state by modifying a size of the photometric area so as to be included within the image pickup area without increasing the calculation cost even when the image pickup area is limited by the objective optical module.

In addition, according to a still further embodiment of the invention, there is provided an image pickup apparatus, including:

a signal processing portion setting a photometric area on an image pickup surface of an image pickup device connected thereto for measuring a light receiving state, as well as setting a size of the photometric area to be variable.

According to the constitution as described above, it is possible to provide an image pickup apparatus having a signal processing portion that has the same effect as the apparatus of claim 1.

According to the image pickup apparatus of the invention, it is possible to carry out a detailed photometry without increasing calculation cost.

### Description of Embodiment

Embodiment of an image pickup apparatus of the invention will be explained in detail below with reference to the drawings.

(Structure of Image Pickup Apparatus)

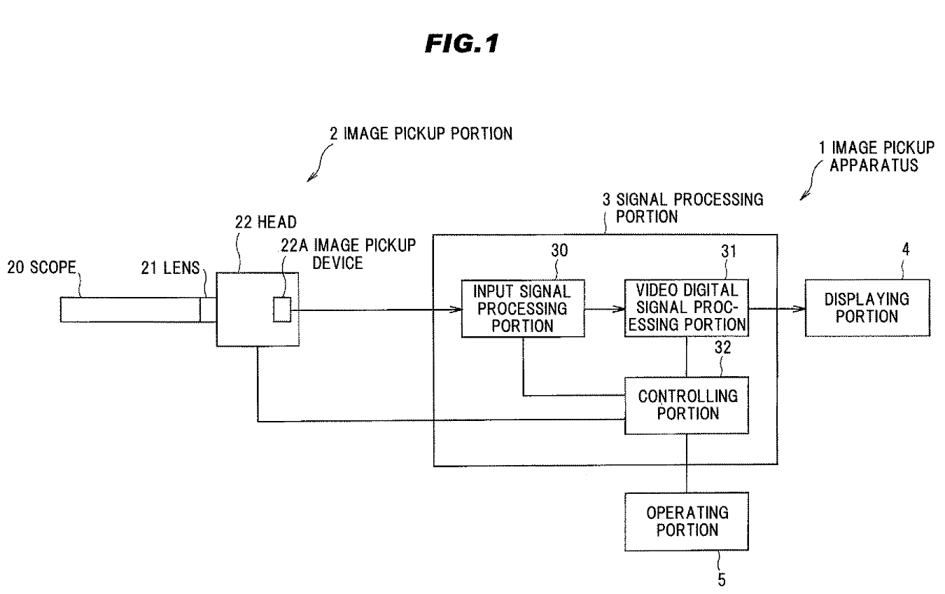

FIG. 1 is a block diagram showing a configuration example of an image pickup apparatus according to an embodiment of the present invention.

An image pickup apparatus 1 includes an image pickup portion 2 for outputting an image pickup signal by filming, a signal processing portion 3 for outputting a video signal by processing the image pickup signal of the image pickup portion 2, a displaying portion 4 using a LCD (Liquid Crystal Display), an organic EL (Electro-Luminescence), or the like for displaying the video signal processed by the signal processing portion 3, and an operating portion 5 composed of plural switches and the like for operating the image pickup apparatus 1.

The image pickup portion 2 includes, for example, a cylindrical scope 20 to be inserted into a cylindrical filmed object and a lens 21 composed of a group of lenses and a lens drive module as objective optical modules, and further includes a head 22 connected to the scope 20 and the lens 21 and an image pickup device 22A such as the CCD, the CMOS, or the like that is provided in the head 22.

The signal processing portion 3 includes an input signal processing portion 30 for outputting a digital video signal by processing an analog image pickup signal inputted from the image pickup device 22A, a video digital signal processing portion 31 for measuring a light receiving state of the video signal outputted by the input signal processing portion 30, and a controlling portion 32 for controlling a motion of the input signal processing portion 30 and the image pickup device 22A based on the light receiving state measured by the video digital signal processing portion 31 and a motion of the video digital signal processing portion 31 based on an operation inputted to the operating portion 5.

The video digital signal processing portion 31 sets the divided photometric areas by, e.g., dividing the image pickup surface into sixteen areas and measures the light receiving state for the video signal corresponding to each divided photometric area. The light receiving state measured by the video digital signal processing portion 31 is inputted to the controlling portion 32. Further, the video digital signal processing portion 31 converts the video signal into a display signal and inputted to the displaying portion 4.

The controlling portion 32 calculates an optimal gain and an optimum exposure time based on the inputted light receiving state, inputs a gain control signal to the input signal processing portion 30, and then, inputs an electronic shutter control signal to the image pickup device 22A. The input signal processing portion 30 processes the video signal by setting the gain based on the gain control signal. The image pickup device 22A determines the exposure time based on the electronic shutter control signal, and outputs the image pickup signal. Note that, the gain here is a conversion magnification of parameter that indicates brightness of the video signal, and the video signal is adjusted to be bright when the gain is increased.

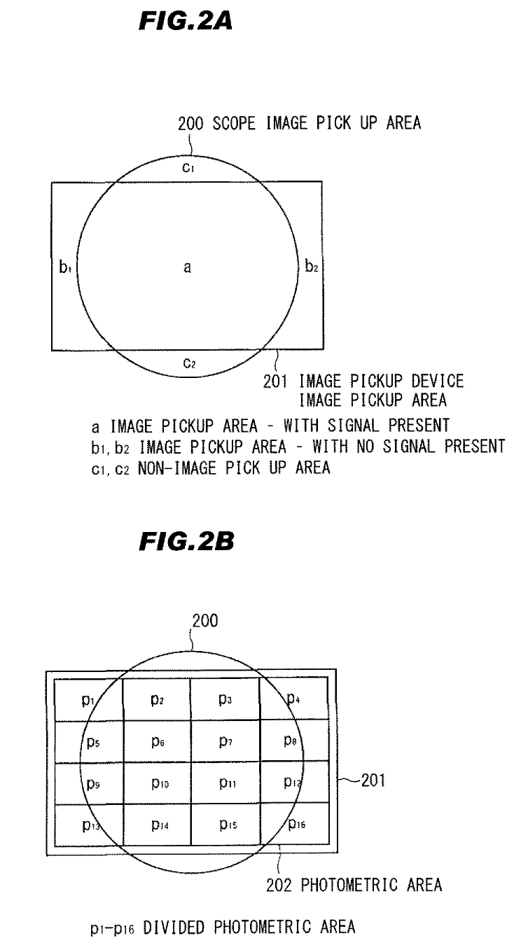

FIGS. 2A and 2B are schematic diagrams showing an image pickup area of the image pickup apparatus according to an embodiment of the invention.

A scope image pickup area 200 is an area allowing the image pickup, which range is limited by a shape of the scope 20. In addition, an image pickup device image pickup area 201 is an area where the image is picked up by the image pickup device 22A. For example, when the both areas overlap as shown in FIG. 2A, the scope image pickup area 200 and the image pickup device image pickup area 201 are divided into an image pickup area a, image pickup areas b₁ and b₂ and non-image pickup areas c₁ and c₂.

The image pickup area a is an area in which an image pickup signal is obtained by the image pickup device 22A. In addition, the image pickup areas b₁ and b₂ are areas in which the image pickup signal is not substantially obtained although an image pickup signal indicating black is obtained. Further, the non-image pickup areas c₁ and c₂ are areas in which the image pickup signal is not obtained as they are out of the image pickup device image pickup area 201.

Meanwhile, as shown in FIG. 2B, a photometric area 202 is a measurement area provided on the image pickup device image pickup area 201 for measuring the light receiving state, and has plural divided photometric areas p₁-p₁₆. For example, in the state shown in FIG. 2B, since p₁, p₄, p₅, p₈, p₉, p₁₂, p₁₃ and p₁₆ include the image pickup areas b₁ and b₂, it is difficult to measure the light receiving state available for the image pickup area a.

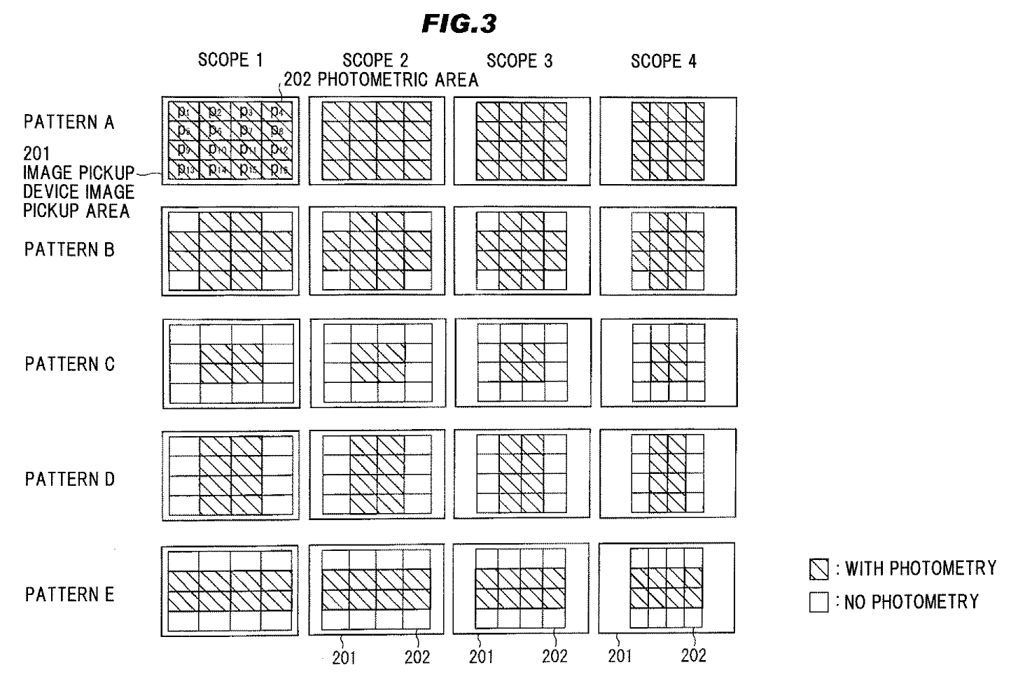

FIG. 3 is a schematic diagram showing a photometric area of the image pickup apparatus according to an embodiment of the invention.

The image pickup device image pickup area 201 has the photometric area 202 therewithin, and a width of the photometric area 202 is small based on the setting of scopes 1 to 4. Further, based on setting of patterns A to E, conditions of “with photometry” and “no photometry” are provided in the divided photometric areas p₁-p₁₆ within the photometric area. In FIG. 3, shadow areas are divided photometric areas where the photometry is carried out and areas without shadow are divided photometric areas in which the photometry is not carried out.

Further, the scopes 1 to 4 and the patterns A to E are selected by a user on a setting screen displayed on the displaying portion 4 using the operating portion 5. Alternatively, the selection may be carried out according to the scope 20 mounted on the image pickup apparatus 1 when shipping from a factory. In addition, the selection may be automatically carried out by setting and using an identification number for identifying the scope 20, or by analyzing the video signal.

(Operation of Image Pickup Apparatus)

An operation of the image pickup apparatus in the embodiment of the invention will be explained below with reference to each drawing.

The image pickup apparatus 1 picks up an image of an object to be filmed by the image pickup device 22A via the scope 20 and the lens 21. The image pickup device 22A outputs an image pickup signal in accordance with the image pickup, and the input signal processing portion 30 outputs a video signal by processing the image pickup signal.

Next, the video digital signal processing portion 31 carries out the measurement of the light receiving state for each video signal corresponding to divided photometric areas provided by dividing an image pickup surface of the image pickup device 22A, and inputs the measured light receiving state to the controlling portion 32. And then, the video signal is converted into a display signal and inputted to the displaying portion 4.

The controlling portion 32 calculates an optimal gain and an optimum exposure time based on the light receiving state, inputs a gain control signal to the input signal processing portion 30, and then, inputs an electronic shutter control signal to the image pickup device 22A. The input signal processing portion 30 processes the video signal by setting the gain based on the gain control signal. The image pickup device 22A determines the exposure time based on the electronic shutter control signal, and outputs the image pickup signal.

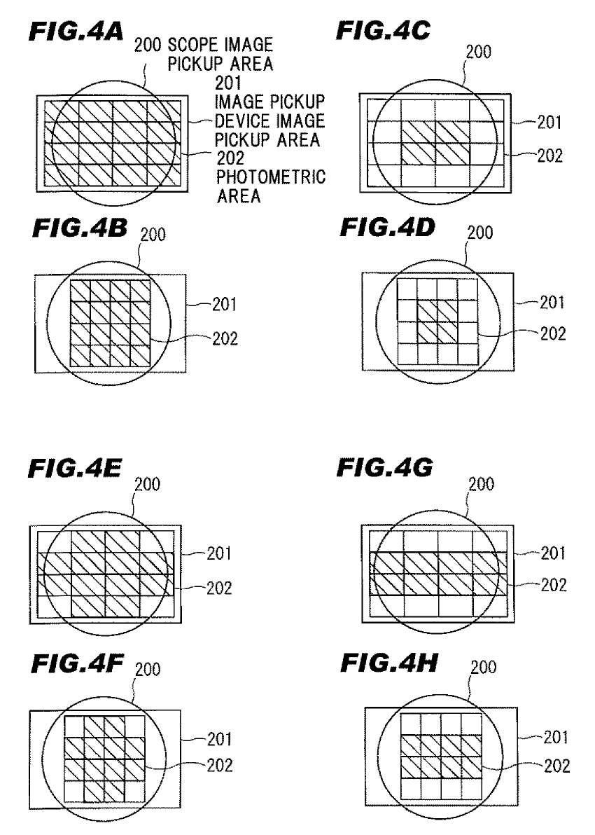

FIGS. 4A to 4H are schematic diagrams showing example operations of the image pickup apparatus according to an embodiment of the invention.

Since the photometric area 202 has divided photometric areas not included within the scope image pickup area 200 in the state shown FIG. 4A, the controlling portion 32 cannot calculate a right light receiving state. Tn contrast, since the photometric area 202 is included within the scope image pickup area 200 in the state shown FIG. 4B, the controlling portion 32 calculates a right light receiving state.

On the other hand, as for the photometric area 202 in the state shown FIG. 4C, although the divided photometric areas in which the photometry is carried out are included within the scope image pickup area 200, the divided photometric areas occupies the most part of the scope image pickup area 200, thus, it is not possible to carry out center-prioritized photometry as an originally expected effect of the pattern C. In contrast, since the divided photometric areas of the photometric area 202 are positioned closer to the center in the scope image pickup area 200 in the state shown FIG. 4D, it is possible to carry out the center-prioritized photometry of the pattern C.

Further, since the photometric area 202 has divided photometric areas not included within the scope image pickup area 200 in the state shown FIG. 4E, the controlling portion 32 cannot calculate a right light receiving state. In contrast, since the photometric area 202 is included within the scope image pickup area 200 in the state shown FIG. 4F, the controlling portion 32 calculates a right light receiving state.

Further, since the photometric area 202 has divided photometric areas not included within the scope image pickup area 200 in the state shown FIG. 4G, the controlling portion 32 cannot calculate a right light receiving state. In contrast, since the photometric area 202 is included within the scope image pickup area 200 in the state shown FIG. 4H, the controlling portion 32 calculates a right light receiving state.

(Effects of Embodiment)

According to the above-mentioned embodiment, since the photometric area 202 can be arbitrarily selected in accordance with the scope image pickup area 200 of the scope 20, it is possible to measure the light receiving state of the scope image pickup area 200 in detail without increasing the division number of the photometric area 202, thereby preventing the increase in the calculation cost of the controlling portion 32.

In addition, the controlling portion 32 can calculate the right light receiving state by not positioning the divided photometric areas outside of the scope image pickup area 200, thereby it is not necessary to apply a specific light receiving state calculating method to the divided photometric areas located outside of the scope image pickup area 200, hence, it is possible to prevent the increase in the calculation cost of the controlling portion 32.

Alternatively, it may be configured not only to vary the size of the photometric area 202 but also to move a center position of the photometric area 202. Further, distribution patterns of the divided photometric areas p₁-p₁₆ may be varied without changing the division number of the photometric area 202. For example, it is possible to minutely carry out the photometry of adjacent spaces except the center by distributing the divided photometric areas in an area excluding the center.

What is claimed is:

1. An image pickup apparatus, comprising:
an image pickup device for picking up an image on an image pickup surface;
an objective optical module connected to the image pickup a device for limiting an image pickup area on the image pickup surface; and
a signal processing portion setting a photometric area on the image pickup surface of the image pickup device for measuring a light receiving state, as well as setting a size of the photometric area to be variable.

2. An image pickup apparatus according to claim 1, wherein the signal processing portion provides the photometric area within the image pickup area that is limited by the objective optical module.

3. An image pickup apparatus according to claim 1, wherein the signal processing portion provides divided photometric areas by dividing the photometric area, and sets a photometric pattern by setting the divided photometric area where the light receiving state is not measured.

4. An image pickup apparatus according to claim 3, wherein the signal processing portion provides the divided photometric areas, where the light receiving state is not measured, within the image pickup area that is limited by the objective optical module.

5. An image pickup apparatus according to claim 1, wherein the signal processing portion controls the image pickup device based on the measured light receiving state.

6. An image pickup apparatus, comprising:
an image pickup device for picking up an image on an image pickup surface;
an objective optical module connected to the image pickup device for limiting an image pickup area on the image pickup surface; and
a signal processing portion setting a photometric area on the image pickup surface of the image pickup device for measuring a light receiving state, as well as setting a size of the photometric area to be variable for providing the photometric area within the image pickup area limited by the objective optical module.

7. An image pickup apparatus according to claim 6, wherein the signal processing portion provides divided photometric areas by dividing the photometric area, and sets a photometric pattern by setting the divided photometric area where the light receiving state is not measured.

8. An image pickup apparatus according to claim 7, wherein the signal processing portion provides the divided photometric areas, where the light receiving state is not measured, within the image pickup area that is limited by the objective optical module.

9. An image pickup apparatus according to claim 6, wherein the signal processing portion controls the image pickup device based on the measured light receiving state.

10. An image pickup apparatus, comprising:
a signal processing portion setting a photometric area on an image pickup surface of an image pickup device connected thereto for measuring a light receiving state, as well as setting a size of the photometric area to be variable.

11. An image pickup apparatus according to claim 10, wherein the signal processing portion provides the photometric area within an image pickup area on the image pickup surface that is limited by the objective optical module connected to the image pickup device.

12. An image pickup apparatus according to claim 10, wherein the signal processing portion provides divided photometric areas by dividing the photometric area, and sets a photometric pattern by setting the divided photometric area where the light receiving state is not measured.

13. An image pickup apparatus according to claim 12, wherein the signal processing portion provides the divided photometric areas, where the light receiving state is not measured, within an image pickup area on the image pickup surface that is limited by the objective optical module connected to the image pickup device.

14. An image pickup apparatus according to claim 10, wherein the signal processing portion controls the image pickup device based on the measured light receiving state.
